(19) United States
(12) Patent Application Publication
(10) Pub. No.: US 2007/0022212 A1
(43) Pub. Date: Jan. 25, 2007

(54) Method and system for TCP large receive offload

(76) Inventor: Kan F. Fan, Diamond Bar, CA (US)

Correspondence Address: MCANDREWS HELD & MALLOY, LTD, 500 WEST MADISON STREET, SUITE 3400, CHICAGO, IL, 60661, US

(21) Appl. No.: 11/488,246

(22) Filed: Jul. 18, 2006

Related U.S. Application Data
(60) Provisional application No. 60/701,723, filed on Jul. 22, 2005.

(51) Int. Cl. G06F 15/173

(52) U.S. Cl. 709/238

(57) ABSTRACT

Certain embodiments of the invention may be found in a method and system for transmission control protocol (TCP) large receive offload. A coalescer may be utilized to collect TCP segments in a network interface card (NIC) without transferring state information to a host system. The collected TCP segments may be buffered in the coalescer. The coalescer may verify that the network connection associated with the collected TCP segments has an entry in a connection lookup table (CLT). When the CLT is full, the coalescer may close a current entry and assign the network connection to the available entry. The coalescer may also update information in the CLT. When an event occurs that terminates the collection of TCP segments, the coalescer may generate a single coalesced TCP segment based on the collected TCP segments. The coalesced TCP segment and state information may be communicated to the host system for processing.

### CROSS-REFERENCE TO RELATED APPLICATIONS/INCORPORATION BY REFERENCE

This patent application makes reference to, claims priority to and claims benefit from U.S. Provisional Patent Application Ser. No. 60/701,723, filed on Jul. 22, 2005.

This application makes reference to:
U.S. Patent Provisional Application Ser. No. 60/789,034 (Attorney Docket No. 17003US01), filed on Apr. 4, 2006;
U.S. Patent Provisional Application Ser. No. 60/788,396 (Attorney Docket No. 17004US01), filed on Mar. 31, 2006;
U.S. Patent Application Ser. No. 11/126,464 (Attorney Docket No. 15774US02), filed on May 11, 2005;
U.S. Patent Application Ser. No. 10/652,270 (Attorney Docket No. 15064US02), filed on Aug. 29, 2003;
U.S. Patent Application Ser. No. 10/652,267 (Attorney Docket No. 13782US03), filed on Aug. 29, 2003; and
U.S. Patent Application Ser. No. 10/652,183 (Attorney Docket No. 13785US02), filed on Aug. 29, 2003.

Each of the above referenced applications is hereby incorporated herein by reference in their entirety.

### FIELD OF THE INVENTION

Certain embodiments of the present invention relate to processing of TCP data and related TCP information. More specifically, certain embodiments relate to a method and system for TCP large receive offload (LRO).

### BACKGROUND OF THE INVENTION

A transmission control protocol/internet protocol (TCP/IP) offload engine (TOE) may be utilized in a network interface card (NIC) to redistribute TCP processing from the host onto specialized processors for handling TCP processing more efficiently. The TOEs may have specialized architectures and suitable software or firmware that allows them to efficiently implement various TCP algorithms for handling faster network connections, thereby allowing host processing resources to be allocated or reallocated to system application processing. In order to alleviate the consumption of host resources by networking applications, at least portions of some applications may be offloaded from a host to a dedicated TOE in a NIC. Some of the host resources released by offloading may include CPU cycles and subsystem memory bandwidth, for example.

While TCP offloading may alleviate some of the network-related processing needs of a host CPU, as transmission speeds continue to increase, the host CPU may not be able to handle the overhead produced by large amounts of TCP data communicated between a sender and a receiver in a network connection. Each TCP packet received as part of the TCP connection incurs host CPU overhead at the moment it arrives, such as CPU cycles spent in the interrupt handler all the way to the stack, for example. If the host CPU is unable to handle the large overhead produced, the host CPU may become the slowest part or the bottleneck in the connection. Reducing networking-related host CPU overhead may provide better overall system performance and may free up the host CPU to perform other tasks.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for TCP large receive offload (LRO), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system that may be utilized in connection with TCP large receive offload, in accordance with an embodiment of the invention.

FIG. 1B is a block diagram of another exemplary system that may be utilized for handling TCP large receive offload, in accordance with an embodiment of the invention.

FIG. 1C is an alternative embodiment of an exemplary system that may be utilized for TCP large receive offload, in accordance with an embodiment of the invention.

FIG. 1D is a block diagram of a system for handling TCP large receive offload, in accordance with an embodiment of the invention

FIG. 1E is a flowchart illustrating exemplary steps for frame reception and placement, in accordance with an embodiment of the invention.

FIG. 2A illustrates an exemplary sequence of TCP/IP frames to be coalesced, in accordance with an embodiment of the invention.

FIG. 2B illustrates an exemplary coalesced TCP/IP frame generated from information in the sequence of TCP frames in FIG. 2A, in accordance with an embodiment of the invention.

FIG. 3 is a flow chart illustrating exemplary steps for TCP large receive offload, in accordance with an embodiment of the invention.

### DETAILED DESCRIPTION OF THE INVENTION

Certain embodiments of the invention may be found in a method and system for TCP large receive offload (LRO). Aspects of the method and system may comprise a coalescer that may be utilized to collect one or more TCP segments in a network interface card (NIC) without transferring state information to a host system. The collected TCP segments may be temporarily buffered in the coalescer. The coalescer may verify that the network connection associated with the collected TCP segments has an entry in a connection lookup table (CLT). When the CLT is full, the coalescer may close a current entry and assign the network connection to the available entry. The coalescer may update information in the CLT. When an event occurs that terminates the collection of TCP segments, the coalescer may generate a single coalesced TCP segment based on the collected TCP segments. The single coalesced TCP segment, which may comprise a plurality of TCP segments, may be referred to as a large receive segment. The coalesced TCP segment and state information may be communicated to the host system for processing.

Under conventional processing, each of the plurality of TCP segments received would have to be individually processed by a host processor in the host system. TCP processing requires extensive CPU processing power in terms of both protocol processing and data placement on the receiver side. Current technologies involve the transfer of TCP state to a dedicated hardware such as a NIC, where it requires significant more changes to host TCP stack and underlying hardware.

However, in accordance with certain embodiments of the invention, providing a single coalesced TCP segment to the host for TCP processing significantly reduces overhead processing by the host. Furthermore, since there is no transfer of TCP state information, dedicated hardware such as a NIC can assist with the processing of received TCP segments by coalescing or aggregating multiple received TCP segments so as to reducing per-packet processing overhead.

In conventional TCP processing systems, it is necessary to know certain information about a TCP connection prior to arrival of a first segment for that TCP connection. In accordance with various embodiments of the invention, it is not necessary to know about the TCP connection prior to arrival of the first TCP segment since the TCP state or context information is still solely managed by the host TCP stack and there is no transfer of state information between the hardware stack and the software stack at any given time.

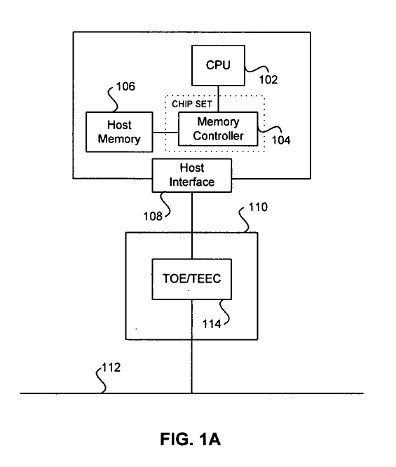

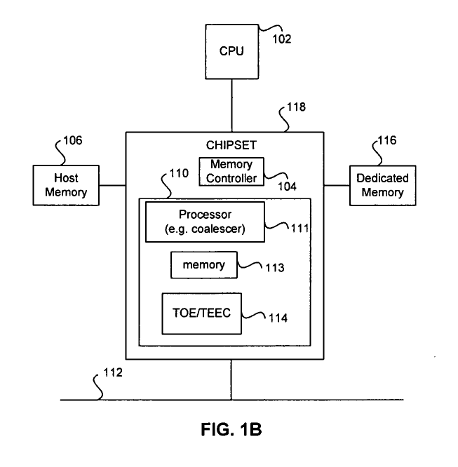

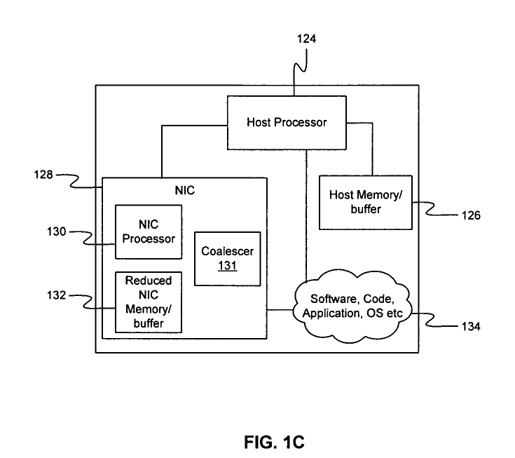

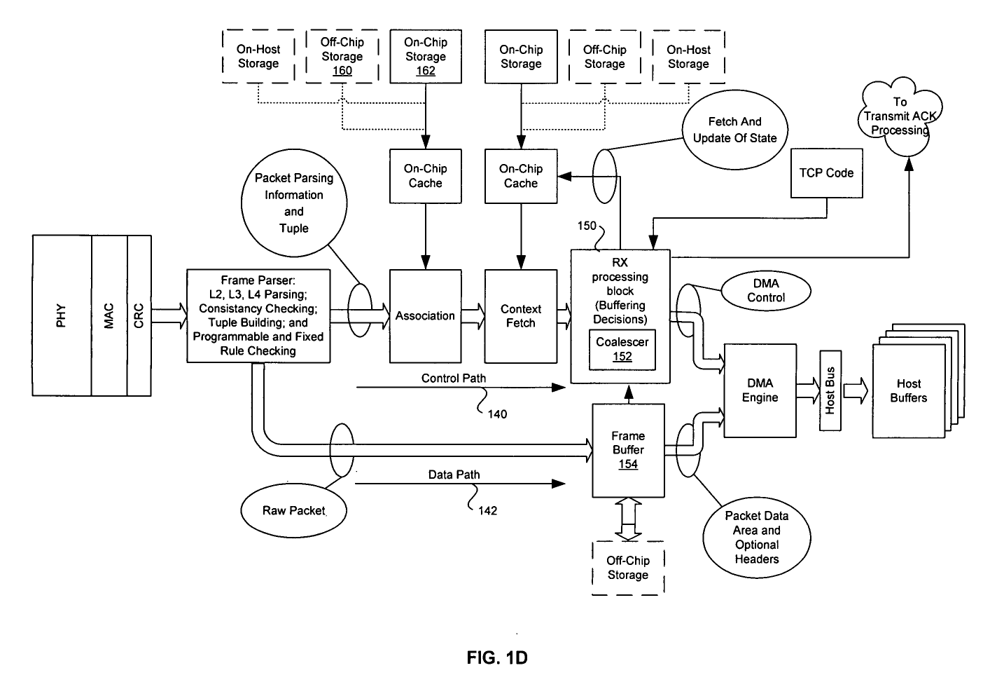

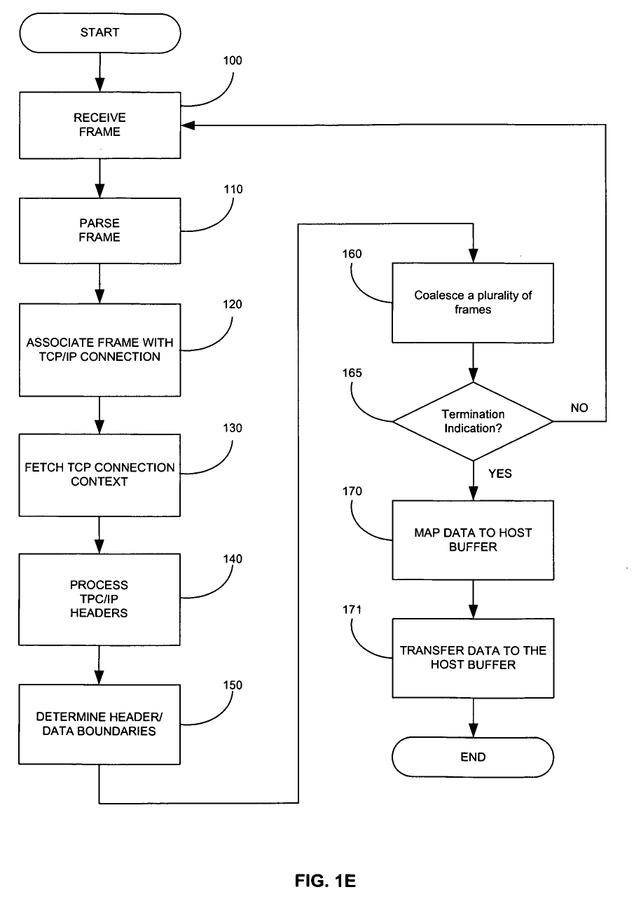

FIG. 1A is a block diagram of an exemplary system that may be utilized in connection with TCP large receive offload, in accordance with an embodiment of the invention. Accordingly, the system of FIG. 1A may be adapted to handle TCP large receive offload of transmission control protocol (TCP) datagrams or packets. Referring to FIG. 1A, the system may include, for example, a CPU 102, a memory controller 104, a host memory 106, a host interface 108, network subsystem 110 and an Ethernet 112. The network subsystem 110 may include, for example, a TCP-enabled Ethernet Controller (TEEC) or a TCP offload engine (TOE) 114. The network subsystem 110 may include, for example, a network interface card (NIC). The host interface 108 may be, for example, a peripheral component interconnect (PCI), PCI-X, PCI Express or other type of bus. The memory controller 106 may be coupled to the CPU 104, to the memory 106 and to the host interface 108. The host interface 108 may be coupled to the network subsystem 110 via the TEEC/TOE 114.

FIG. 1B is a block diagram of another exemplary system that may be utilized for handling TCP large receive offload, in accordance with an embodiment of the invention. Referring to FIG. 1B, the system may include, for example, a CPU 102, a host memory 106, a dedicated memory 116 and a chip set 118. The chip set 118 may include, for example, the network subsystem 110 and the memory controller 104. The chip set 118 may be coupled to the CPU 102, to the host memory 106, to the dedicated memory 116 and to the Ethernet 112. The network subsystem 110 of the chip set 118 may be coupled to the Ethernet 112. The network subsystem 110 may include, for example, the TEEC/TOE 114 that may be coupled to the Ethernet 112. The network subsystem 110 may communicate to the Ethernet 112 via a wired and/or a wireless connection, for example. The wireless connection may be a wireless local area network (WLAN) connection as supported by the IEEE 802.11 standards, for example. The network subsystem 110 may also include, for example, a memory 113. The dedicated memory 116 may provide buffers for context and/or data.

The network subsystem 110 may comprise a processor such as a coalescer 111. The coalescer 111 may comprise suitable logic, circuitry and/or code that may be enabled to handle the accumulation or coalescing of TCP data. In this regard, the coalescer 111 may utilize a connection lookup table (CLT) to maintain information regarding current network connections for which TCP segments are being collected for aggregation. The CLT may be stored in, for example, the network subsystem 110. The CLT may comprise at least one of the following: a source IP address, a destination IP address, a source TCP port, a destination TCP port, a start TCP segment, and/or a number of TCP bytes being received, for example. The CLT may also comprise at least one of a host buffer or memory address including a scatter-gather-list (SGL) for non-continuous memory, a cumulative acknowledgments (ACKs), a copy of a TCP header and options, a copy of an IP header and options, a copy of an Ethernet header, and/or accumulated TCP flags, for example.

The coalescer 111 may be enabled to generate a single coalesced TCP segment from the accumulated or collected TCP segments when a termination event occurs. The single coalesced TCP segment may be communicated to the host memory 106, for example.

Although illustrated, for example, as a CPU and an Ethernet, the present invention need not be so limited to such examples and may employ, for example, any type of processor and any type of data link layer or physical media, respectively. Accordingly, although illustrated as coupled to the Ethernet 112, the TEEC or the TOE 114 of FIG. 1A may be adapted for any type of data link layer or physical media. Furthermore, the present invention also contemplates different degrees of integration and separation between the components illustrated in FIGS. 1A-B. For example, the TEEC/TOE 114 may be a separate integrated chip from the chip set 118 embedded on a motherboard or may be embedded in a NIC. Similarly, the coalescer 111 may be a separate integrated chip from the chip set 118 embedded on a motherboard or may be embedded in a NIC. In addition, the dedicated memory 116 may be integrated with the chip set 118 or may be integrated with the network subsystem 110 of FIG.1B.

Some embodiments of the TEEC portion of the TEEC/TOE 114 are described in, for example, U.S. patent application Ser. No. 10/652,267 (Attorney Docket No. 13782US03) filed on Aug. 29, 2003. The above-referenced United States patent application is hereby incorporated herein by reference in its entirety.

Embodiments of the TOE portion of the TEEC/TOE 114 are described in, for example, U.S. patent application Ser. No. 10/652,183, (Attorney Docket No. 13785US02) filed on Aug. 29, 2003. The above-referenced United States patent applications are all hereby incorporated herein by reference in their entirety.

FIG. 1C is an alternative embodiment of an exemplary system that may be utilized for TCP large receive offload, in accordance with an embodiment of the invention. Referring to FIG. 1C, there is shown a host processor 124, a host memory/buffer 126, a software algorithm block 134 and a NIC block 128. The NIC block 128 may include a NIC processor 130, a processor such as a coalescer 131 and a reduced NIC memory/buffer block 132. The NIC block 128 may communicate with an external network via a wired and/or a wireless connection, for example. The wireless connection may be a wireless local area network (WLAN) connection as supported by the IEEE 802.11 standards, for example.

The coalescer 131 may be a dedicated processor or hardware state machine sitting in the packet-receiving path. The host TCP stack is the software that manages the TCP protocol processing and is typical a part of an operating system, such as Microsoft Windows or Linux. The coalescer 131 may comprise suitable logic, circuitry and/or code that may enable accumulation or coalescing of TCP data. In this regard, the coalescer 131 may utilize a connection lookup table (CLT) to maintain information regarding current network connections for which TCP segments are being collected for aggregation. The CLT may be stored in, for example, the reduced NIC memory/buffer block 132. The coalescer 131 may enable generation of a single coalesced TCP segment from the accumulated or collected TCP segments when a termination event occurs. The single coalesced TCP segment may be communicated to the host memory/buffer 126, for example.

FIG. 1D is a block diagram of a system for handling TCP large receive offload, in accordance with an embodiment of the invention. Referring to FIG. 1D, the incoming frame may be subject to L2 such as Ethernet processing including, for example, address filtering, frame validity and error detection. Unlike an ordinary Ethernet controller, the next stage of processing may include, for example, L3 such as IP processing and L4 such as TCP processing. The host CPU utilization and memory bandwidth may be reduced by, for example, processing traffic on hardware offloaded TCP/IP connections. The protocol to which incoming packets belong may be detected. Once a connection has been associated with a packet or frame, any higher level of processing such as L5 or above may be achieved. The destination of the payload data may be determined from the connection state information in combination with direction information within the frame. The destination may be a host memory, for example.

The receive system architecture may include, for example, a control path processing 140 and data movement engine 142. The system components above the control path as illustrated in upper portion of FIG. 1D, may be designed to deal with the various processing stages used to complete, for example, the L3/L4 or higher processing with maximal flexibility and efficiency and targeting wire speed. The result of the stages of processing may include, for example, one or more packet identification cards (PID_Cs) that may provide a control structure that may carry information associated with the frame payload data. A data movement system as illustrated in the lower portion of FIG. 1D, may move the payload data portions of a frame along from, for example, an on-chip packet buffer and upon control processing completion, to a direct memory access (DMA) engine and subsequently to the host buffer that was chosen via processing.

The receiving system may perform, for example, one or more of the following: parsing the TCP/IP headers; associating the frame with an end-to-end TCP/IP connection; fetching the TCP connection context; processing the TCP/IP headers; determining header/data boundaries; mapping the data to a host buffer(s); and transferring the data via a DMA engine into these buffer(s). The headers may be consumed on chip or transferred to the host via the DMA engine.

The packet buffer may be an optional block in the receive system architecture. It may be utilized for the same purpose as, for example, a first-in-first-out (FIFO) data structure is used in a conventional L2 NIC or for storing higher layer traffic for additional processing. The packet buffer in the receive system need not be limited to a single instance. As control path processing is performed, the data path may store the data between data processing stages one or more times depending, for example, on protocol requirements.

In an exemplary embodiment of the invention, at least a portion of the coalescing operations described for the coalescer 111 in FIG. 1B and/or for the coalescer 131 in FIG. 1C may be implemented in a coalescer 152 in a RX processing block 150 in FIG. 1D. In this instance, buffering or storage of TCP data may be performed by, for example, the frame buffer 154. Moreover, the CLT utilized by the coalescer 152 may be implemented using the off-chip storage 160 and/or the on-chip storage 162, for example.

FIG. 1E is a flowchart illustrating exemplary steps for frame reception and placement in accordance with an embodiment of the invention. Referring to FIG. 1D and FIG. 1E, in step 100, the network subsystem 110 may receive a frame from, for example, the Ethernet 112. In step 110, a frame parser may parse the frame, for example, to find the L3 and L4 headers. The frame parser may process the L2 headers leading up to the L3 header, for example IP version 4 (IPv4) header or IP version 6 (IPv6) header. The IP header version field may determine whether the frame carries an IPv4 datagram or an IPv6 datagram.

For example, if the IP header version field carries a value of 4, then the frame may carry an IPv4 datagram. If, for example, the IP header version field carries a value of 6, then the frame may carry an IPv6 datagram. The IP header fields may be extracted, thereby obtaining, for example, the IP source (IP SRC) address, the IP destination (IP DST) address, and the IPv4 header “Protocol” field or the IPv6 “Next Header”. If the IPv4 “Protocol” header field or the IPv6 “Next Header” header field carries a value of 6, then the following header may be a TCP header. The results of the parsing may be added to the PID_C and the PID_C may travel with the packet inside the TEEC/TOE 114.

The rest of the IP processing may subsequently occur in a manner similar to the processing in a conventional off-the-shelf software stack. Implementation may vary from the use of firmware on an embedded processor to a dedicated, finite state machine, which may be potentially faster, or a hybrid of a processor and a state machine. The implementation may vary with, for example, multiple stages of processing by one or more processors, state machines, or hybrids. The IP processing may include, but is not limited to, extracting information relating to, for example, length, validity and fragmentation. The located TCP header may also be parsed and processed. The parsing of the TCP header may extract information relating to, for example, the source port and the destination port of the particular network connection associated with the received frame.

The TCP processing may be divided into a plurality of additional processing stages. In step 120, the frame may be associated with an end-to-end TCP/IP connection. After L2 processing, in one embodiment, the present invention may provide that the TCP checksum be verified. The end-to-end connection may be defined by, for example, at least a portion of the following 5-tuple: IP Source address (IP SRC addr); IP destination address (IP DST addr); L4 protocol above the IP protocol such as TCP, UDP or other upper layer protocol; TCP source port number (TCP SRC); and TCP destination port number (TCP DST). The process may be applicable for IPv4 or IPv6 with the choice of the relevant IP address.

As a result of the frame parsing in step 110, the 5-tuple may be completely extracted and may be available inside the PID_C. Association hardware may compare the received 5-tuple with a list of 5-tuples stored in the TEEC/TOE 114. The TEEC/TOE 114 may maintain a list of tuples representing, for example, previously handled off-loaded connections or off-loaded connections being managed by the TEEC/TOE 114. The memory resources used for storing the association information may be costly for on-chip and off-chip options. Therefore, it is possible that not all of the association information may be housed on chip. A cache may be used to store the most active connections on chip. If a match is found, then the TEEC/TOE 114 may be managing the particular TCP/IP connection with the matching 5-tuple.

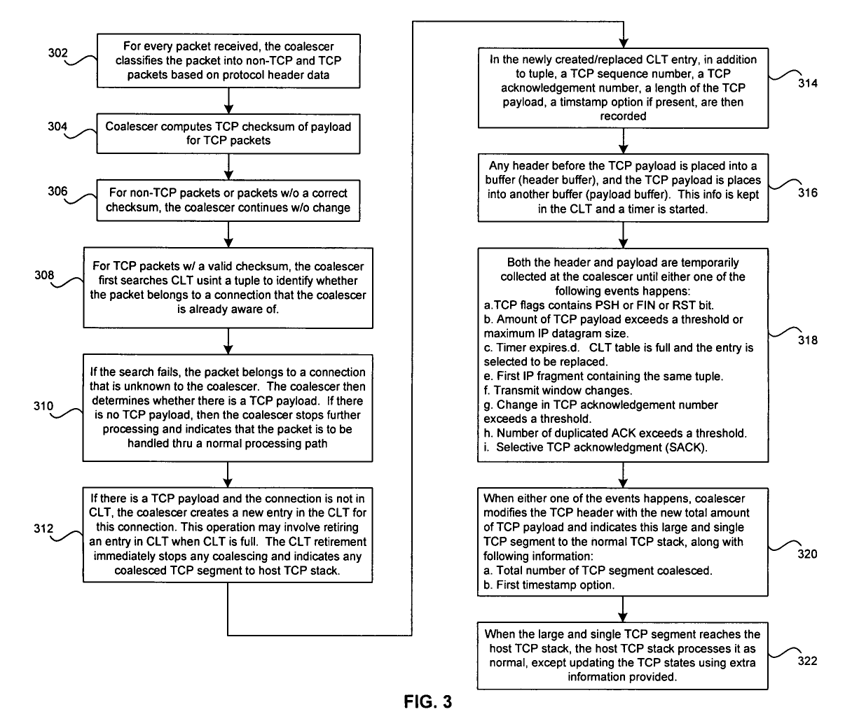

In step 130, the TCP connection context may be fetched. In step 140, the TCP/IP headers may be processed. In step 150, header/data boundaries may be determined. In step 160, a coalescer may collect or accumulate a plurality of frames that may be associated with a particular network connection not handled as an offloaded connection by the TOE. In this regard, the TCP segments collected by the coalescer may not be associated with an offloaded connection since the stack processing on the collected TCP segments occurs at the host stack. The collected TCP segments and the collected information regarding the TCP/IP connection may be utilized to generate a TCP/IP frame comprising a single coalesced TCP segment, for example. In step 165, when a termination event occurs, the process may proceed to step 170. A termination event may be an incident, instance, and/or a signal that indicates to the coalescer that collection or accumulation of TCP segments may be completed and that the single coalesced TCP segment may be communicated to a host system for processing. At least a portion of the termination events that may be utilized when generating a TCP large receive offload are described in FIG. 3. In step 170, payload data corresponding to the single coalesced TCP segment may be mapped to the host buffer. In step 171, data from the single coalesced TCP segment may be transferred to the host buffer. Returning to step 165, when a termination event does not occur, the process may proceed to step 100 and a next received frame may be processed.

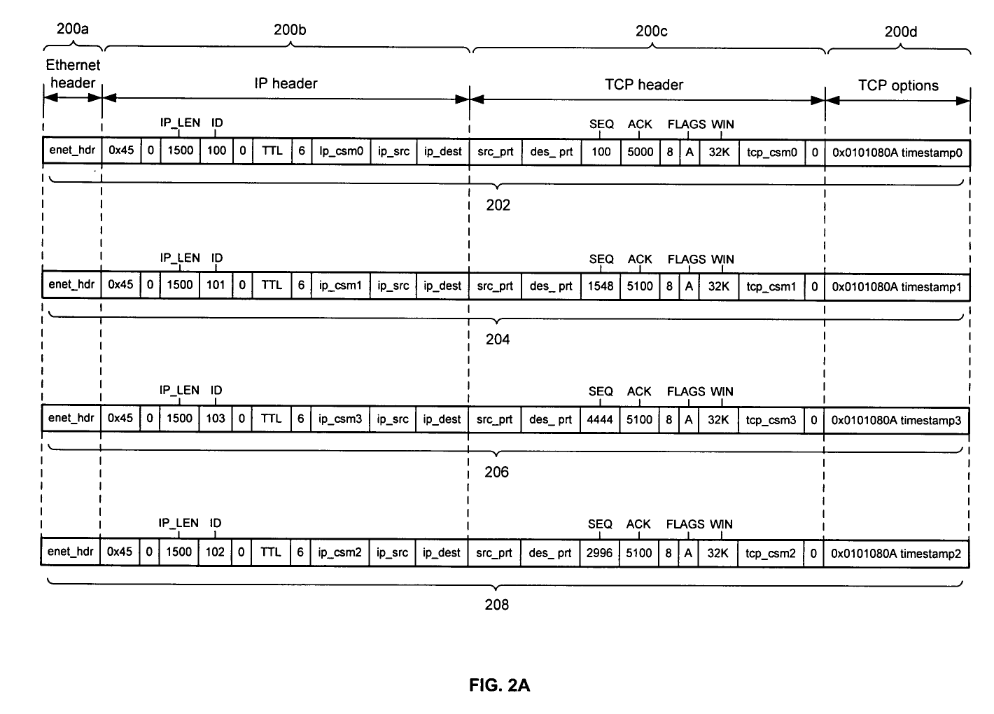

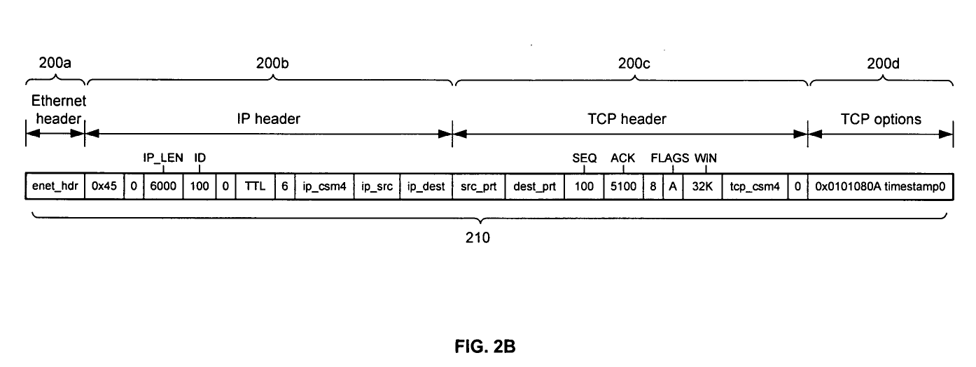

FIG. 2A illustrates an exemplary sequence of TCP/IP frames to be coalesced, in accordance with an embodiment of the invention. Referring to FIG. 2, there are shown a first TCP/IP frame 202, a second TCP/IP frame 204, a third TCP/IP frame 206, and a fourth TCP/IP frame 208. Each TCP/IP frame shown may comprise an Ethernet header 200a, an IP header 200b, a TCP header 200c, and a TCP options 200d. While not shown in FIG. 2A, each of the TCP/IP frames may comprise a payload portion that contains TCP segments comprising packets of data. The Ethernet header 200a may have the same value, enet_hdr, for all TCP/IP frames. The IP header 200b may comprise a plurality of fields. In this regard, the IP header 200b may comprise a field, IP_LEN, which may be utilized to indicate a number of packets in the frames. In this example, there are 1500 packets in each of the first TCP/IP frame 202, the second TCP/IP frame 204, the third TCP/IP frame 206, and the fourth TCP/IP frame 208.

The IP header 200b may also comprise an identification field, ID, which may be utilized to identify the frame, for example. In this example, ID=100 for the first TCP/IP frame 202, ID=101 for the second TCP/IP frame 204, ID=103 for the third TCP/IP frame 206, and ID=102 for the fourth TCP/IP frame 208. The IP header 200b may also comprise additional fields such as an IP header checksum field, ip_csm, a source field, ip_src, and a destination field, ip_dest, for example. In this example, the value of ip_src and ip_dest may be the same for all frames, while the value of the IP header checksum field may be ip_csm0 for the first TCP/IP frame 202, ip_csm1 for the second TCP/IP frame 204, ip_csm3 for the third TCP/IP frame 206, and ip_csm2 for the fourth TCP/IP frame 208.

The TCP header 200c may comprise a plurality of fields. For example, the TCP header 200c may comprise a source port field, src_prt, a destination port field, dest_prt, a TCP sequence field, SEQ, an acknowledgment field, ACK, a flags field, FLAGS, a transmission window field, WIN, and a TCP header checksum field, tcp_csm. In this example, the value of src_prt, dest_prt, FLAGS, and WIN may be the same for all frames. For the first TCP/IP frame 202, SEQ=100, ACK=5000, and the TCP header checksum field is tcp_csm0. For the second TCP/IP frame 204, SEQ=1548, ACK=5100, and the TCP header checksum field is tcp_csm1. For the third TCP/IP frame 206, SEQ=4444, ACK=5100, and the TCP header checksum field is tcp_csm3. For the fourth TCP/IP frame 208, SEQ=2996, ACK=5100, and the TCP header checksum field is tcp_csm2.

The TCP options 200d may comprise a plurality of fields. For example, the TCP options 200d may comprise a time stamp indicator, referred to as timestamp, which is associated with the TCP frame. In this example, the value of the time stamp indicator may be timestamp0 for the first TCP/IP frame 202, timestamp1 for the second TCP/IP frame 204, timestamp3 for the third TCP/IP frame 206, and timestamp2 for the fourth TCP/IP frame 208.

The exemplary sequence of TCP/IP frames shown in FIG. 2A is received out-of-order with respect to the order of transmission by the network subsystem 110, for example. Information comprised in the TCP sequence number may indicate that the third TCP/IP frame 206 and the fourth TCP/IP frame 208 were received in a different order from the order of transmission. In this instance, the fourth TCP/IP frame 208 was transmitted after the second TCP/IP frame 204 and before the third TCP/IP frame 206. A coalescer, such as the coalescers described in FIGS. 1B-1E may obtain information from the TCP/IP frames and may generate a single TCP/IP frame by coalescing the information received. In this regard, the coalescer may utilize a CLT to store and/or update at least a portion of the information received from the TCP/IP frames. The coalescer may also utilize available memory to store or buffer the payload of the coalesced TCP/IP frame.

FIG. 2B illustrates an exemplary coalesced TCP/IP frame generated from information in the sequence of TCP frames in FIG. 2A, in accordance with an embodiment of the invention. Referring to FIG. 2B, there is shown a single TCP/IP frame 210 that may be generated by a coalescer from the sequence of TCP/IP frames received in FIG. 2A. The TCP/IP frame 210 may comprise an Ethernet header 200a, an IP header 200b, a TCP header 200c, and a TCP options 200d. While not shown, the TCP/IP frame 210 may also comprise a payload that contains TCP segments comprising data packets from the TCP/IP frames received. The fields in the Ethernet header 200a, the IP header 200b, the TCP header 200c, and the TCP options 200d in the TCP/IP frame 210 may be substantially similar to the fields in the TCP/IP frames in FIG. 2A. For the TCP/IP frame 210, the total number of packets in the payload is IP_LEN=6000, which corresponds to the sum of the packets for all four TCP/IP frames in FIG. 2A. For the TCP/IP frame 210, the value of ID=100, which corresponds to the ID value of the first TCP/IP frame 202. Moreover, the value of the time stamp indicator is timestamp0, which corresponds to the time stamp indicator of the first TCP/IP frame 202. The TCP/IP frame 210 may be communicated or transferred to a host system for TCP processing, for example.

FIG. 3 is a flow chart illustrating exemplary steps for TCP large receive offload, in accordance with an embodiment of the invention. Referring to FIG. 3, in step 302, for every packet received, the coalescer 131, for example, may classify the packets into non-TCP and TCP packets by examining the protocol headers. In step 306, the coalescer 131 may compute the TCP checksum of the payload. In step 304, for non-TCP packets or packet without correct checksum, the coalescer 131 may continue processing without change. In step 308, for TCP packets with valid checksum, the coalescer 131 first searches the connection lookup table (CLT) using a tuple comprising IP source address, IP destination address, source TCP port and destination TCP port, to determine whether the packet belongs to a connection that the coalescer 131 is already aware of.

In step 310, in instances where the search fails, this packet may belong to a connection that is not known to the coalescer 131. The coalescer 131 may determine whether there is any TCP payload. If there is no TCP payload, for example, pure TCP ACK, the coalescer 131 may stop further processing and allow processing of the packet through a normal processing path. In step 312, if there is TCP payload and the connection is not in the CLT, the coalescer 131 may create a new entry in the CLT for this connection. This operation may involve retiring an entry in the CLT when the CLT is full. The CLT retirement may immediately stop any further coalescing and provides an indication of any coalesced TCP segment to host TCP stack.

In step 314, if the newly created/replaced CLT entry, in addition to tuple, a TCP sequence number, a TCP acknowledgement number, a length of the TCP payload, and a timestamp option if present, may be recorded. In step 316, any header before TCP payload may be placed into a buffer (Header Buffer), whereas the TCP payload may be placed into another buffer (Payload Buffer). This information may also be kept in the CLT and a timer also started. In step 318, both the header and the payload are temporarily collected at coalescer 131 until either one of the following termination events happens:

a. TCP flags comprising PSH or FIN or RST or any of ECN bits.

b. An amount of TCP payload exceeds a threshold or maximum IP datagram size.

c. A timer expires.

d. A CLT table is full and one of the current network connection entries is replaced with an entry associated with a new network connection.

e. A first IP fragment containing the same tuple is detected.

f. A transmit window size changes.

g. A change in TCP acknowledgement (ACK) number exceeds an ACK threshold.

h. A number of duplicated ACK exceeds a duplicated ACK threshold.

i. A selective TCP acknowledgment (SACK).

In this regard, the PSH bit may refer to a control bit that indicates that a segment contains data that must be pushed through to the receiving user. The FIN bit may refer to a control bit that indicates that the sender will send no more data or control occupying sequence space. The RST bit may refer to a control bit that indicates a reset operation where the receiver should delete the connection without further interaction. The ECN bits may refer to explicit congestion notification bits that may be utilized for congestion control. The ACK bit may refer to a control bit that indicates that the acknowledgment field of the segment specifies the next sequence number the sender of this segment is expecting to receive, hence acknowledging receipt of all previous sequence numbers.

In step 320, when either one of these events happens, the coalescer 131 may modify the TCP header with the new total amount of TCP payload and indicates this large and single TCP segment to the normal TCP stack, along with following information: A total number of TCP segment coalesced and/or a first timestamp option. In step 322, when the large and single TCP segment reaches the host TCP stack, the host TCP stack processes it as normal.

The hardware stack that may be located on the NIC is adapted to take the packets off the wire and accumulate or coalesce them independent of the TCP stack running on the host processor. For example, the data portion of a plurality of received packets may be accumulated in the host memory until a single large TCP receive packet of, for example 8-10K is created. Once the single large TCP receive packet is generated, it may then be transferred to the host for processing. In this regard, the hardware stack may be adapted to build state and context information when it sees the received TCP packets. This significantly reduces the computation intensive tasks associated with TCP stack processing. While the data portion of a plurality of received packets is being accumulated in the host memory, this data remains under the control of the NIC.

Although the handling of a single TCP connection is illustrated, the invention is not limited in this regard. Accordingly, various embodiments of the invention may provide support for a plurality of TCP connections over multiple physical networking ports.

Coalescing received TCP packets may reduce the networking-related host CPU overhead and may provide better overall system performance while also freeing up the host CPU to perform other tasks.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for handling network processing of network information, the method comprising:
updating connection information which is stored in a connection lookup table (CLT) on a network interface card (NIC) for a large receive offload (LRO) packet prior to occurrence of a termination event; and
in response to receiving at least one signal indicating occurrence of said termination event, communicating said updated connection information and said LRO packet to a host communicatively coupled to said NIC.

2. The method according to claim 1, comprising updating connection information in said CLT for a plurality of LRO packets.

3. The method according to claim 1, wherein said connection information in said CLT comprises at least one of the following:
a tuple comprising:
an Internet protocol (IP) source address;
an IP destination address;
a source TCP port; and
a destination TCP port;
a TCP sequence number;
a TCP acknowledgment number; and
a TCP payload length.

4. The method according to claim 1, comprising closing an entry in said CLT associated with said connection information after said termination event occurs.

5. The method according to claim 1, comprising opening an entry in said CLT associated with connection information for a new LRO packet.

6. The method according to claim 1, comprising generating at least one signal for communicating said updated connection information and said LRO packet to said host.

7. The method according to claim 1, wherein said termination event occurs when at least one of the following occurs:
a TCP/Internet Protocol (TCP/IP) frame associated with said LRO packet comprises a TCP flag with at least one of a PSH bit, a FIN bit, or a RST bit;
a TCP/IP frame associated with said LRO packet comprises a TCP payload length that is equal to or greater than a maximum IP datagram size;
a timer associated with processing of said LRO packet expires;
a new entry in said CLT is generated when said CLT is full;
a first IP fragment associated with said LRO packet is received;
a transmit window is modified;
a change in a number of TCP acknowledgments (ACKS) is greater than or equal to an ACK threshold; and
a TCP/IP frame associated with said LRO packet comprises a number of duplicated TCP acknowledgments that is equal to or greater than a duplicated ACK threshold.

8. A machine-readable storage having stored thereon, a computer program having at least one code for handling network processing of network information, the at least one code section being executable by a machine for causing the machine to perform steps comprising:
updating connection information which is stored in a connection lookup table (CLT) on a network interface card (NIC) for a large receive offload (LRO) packet prior to occurrence of a termination event; and
in response to receiving at least one signal indicating occurrence of said termination event, communicating said updated connection information and said LRO packet to a host communicatively coupled to said NIC.

9. The machine-readable storage according to claim 8, comprising code for updating connection information in said CLT for a plurality of LRO packets.

10. The machine-readable storage according to claim 8, wherein said connection information in said CLT comprises at least one of the following:
a tuple comprising:
an Internet protocol (IP) source address;
an IP destination address;
a source TCP port; and
a destination TCP port;
a TCP sequence number;
a TCP acknowledgment number; and
a TCP payload length.

11. The machine-readable storage according to claim 8, comprising code for closing an entry in said CLT associated with said connection information after said termination event occurs.

12. The machine-readable storage according to claim 8, comprising code for opening an entry in said CLT associated with connection information for a new LRO packet.

13. The machine-readable storage according to claim 8, comprising code for generating at least one signal for communicating said updated connection information and said LRO packet to said host.

14. The machine-readable storage according to claim 8, wherein said termination event occurs when at least one of the following occurs:
a TCP/Internet Protocol (TCP/IP) frame associated with said LRO packet comprises a TCP flag with at least one of a PSH bit, a FIN bit, or a RST bit;
a TCP/IP frame associated with said LRO packet comprises a TCP payload length that is equal to or greater than a maximum IP datagram size;
a timer associated with processing of said LRO packet expires;
a new entry in said CLT is generated when said CLT is full;
a first IP fragment associated with said LRO packet is received;
a transmit window is modified;
a change in a number of TCP acknowledgments (ACKS) is greater than or equal to an ACK threshold; and
a TCP/IP frame associated with said LRO packet comprises a number of duplicated TCP acknowledgments that is equal to or greater than a duplicated ACK threshold.

15. A system for handling network processing of network information, the system comprising:
a network interface card (NIC) that comprises a processor and a memory;
said processor enables updating connection information which is stored in a connection lookup table (CLT) in said memory for a large receive offload (LRO) packet prior to occurrence of a termination event; and
in response to receiving at least one signal indicating occurrence of said termination event, said processor enables communicating said updated connection information and said LRO packet to a host communicatively coupled to said NIC.

16. The system according to claim 1, wherein said processor enables updating connection information in said CLT for a plurality of LRO packets.

17. The system according to claim 1, wherein said connection information in said CLT comprises at least one of the following:
a tuple comprising:
an Internet protocol (IP) source address;
an IP destination address;
a source TCP port; and
a destination TCP port;
a TCP sequence number;
a TCP acknowledgment number; and
a TCP payload length.

18. The system according to claim 1, wherein said processor enables closing an entry in said CLT associated with said connection information after said termination event occurs.

19. The system according to claim 1, wherein said processor enables opening an entry in said CLT associated with connection information for a new LRO packet.

20. The system according to claim 1, wherein said processor enables generating at least one signal for communicating said updated connection information and said LRO packet to said host.

21. The system according to claim 1, wherein said termination event occurs when at least one of the following occurs:
a TCP/Internet Protocol (TCP/IP) frame associated with said LRO packet comprises a TCP flag with at least one of a PSH bit, a FIN bit, or a RST bit;
a TCP/IP frame associated with said LRO packet comprises a TCP payload length that is equal to or greater than a maximum IP datagram size;
a timer associated with processing of said LRO packet expires;
a new entry in said CLT is generated when said CLT is full;
a first IP fragment associated with said LRO packet is received;
a transmit window is modified;
a change in a number of TCP acknowledgments (ACKS) is greater than or equal to an ACK threshold; and
a TCP/IP frame associated with said LRO packet comprises a number of duplicated TCP acknowledgments that is equal to or greater than a duplicated ACK threshold.
